(19) United States
(12) Patent Application Publication
(10) Pub. No.: US 2009/0237340 A1
(43) Pub. Date: Sep. 24, 2009

(54) LIQUID CRYSTAL DISPLAY MODULE AND DISPLAY SYSTEM INCLUDING THE SAME

(76) Inventors: Joo-Hwan PARK, Suwon-si (KR); Seong-Il Kim, Cheonan-si (KR); Kyung-Woo Kim, Cheonan-si (KR); Gyu-Su Lee, Seoul (KR); Dae-Young Joung, Seoul (KR); Jun-Ho Hwang, Asan-si (KR); Jung-Hoon Ku, Seoul (KR); Choong-Hwa Kim, Seongnam-si (KR); Ri-Na You, Seoul (KR)

Correspondence Address: Haynes and Boone, LLP;IP Section, 2323 Victory Avenue, SUITE 700, Dallas, TX, 75219, US

(21) Appl. No.: 12/407,629

(22) Filed: Mar. 19, 2009

(30) Foreign Application Priority Data
Mar. 19, 2008 (KR) 10-2008-0025531

(51) Int. Cl. G09G 3/36

(52) U.S. Cl. 345/90; 345/92

(57) ABSTRACT

A liquid crystal display (LCD) module and a display system including the LCD module are provided. The LCD module includes a common-voltage adjustment unit which is enabled by interfacing with an external device and thus adjusts a common voltage; a signal control unit which outputs a first reverse signal that reverses the polarity of a voltage at intervals of at least two frames; and a data driving unit which reverses the polarity of an image data voltage with respect to the common voltage at intervals of at least two frames in response to the first reverse signal.

### CROSS-REFERENCE TO RELATED APPLICATION

This application claims priority from Korean Patent Application No. 10-2008-0025531 filed on Mar. 19, 2008 in the Korean Intellectual Property Office, the disclosure of which is incorporated herein by reference in its entirety.

### BACKGROUND OF THE INVENTION

1. Field of the Invention

The present invention relates to a liquid crystal display (LCD) module and a display system including the same.

2. Description of the Related Art

A liquid crystal display (LCD) module includes a first substrate formed with a plurality of pixel electrodes and a plurality of thin-film transistors (TFTs), a second substrate formed with a common electrode and a plurality of color filters, and a liquid crystal layer interposed between the first and second substrates. Liquid crystal molecules in the liquid crystal layer are inclined according to an electric potential difference between the pixel electrodes and the common electrode, thereby displaying an image. A data voltage is applied to the pixel electrodes, and a common voltage is applied to the common electrode. More specifically, two data voltages, which are positive and negative with respect to the common voltage, are applied to the pixel electrodes in each frame.

However, flicker may occur due to a “kickback” phenomenon, which may distort the voltage of a common electrode, thereby reducing the display quality of an image. Thus, in order to improve the display quality, it is necessary to reduce flicker and prevent the distortion of the common voltage.

Moreover, when the frame frequency of an LCD module is high, it is difficult to adjust the common voltage to reduce flicker. If the minimization of flicker fails, the display quality of an image may deteriorate.

### SUMMARY OF THE INVENTION

Aspects of the present invention provide a liquid crystal display (LCD) module which can improve the display quality of an image.

Aspects of the present invention also provide a display system which can improve the display quality of an image.

However, the aspects, features and advantages of the present invention are not restricted to those set forth herein. The above and other aspects, features and advantages of the present invention will become more apparent to one of ordinary skill in the art to which the present invention pertains by referencing a detailed description of the present invention given below.

According to an aspect of the present invention, there is provided an LCD module including: a common-voltage adjustment unit which is enabled by interfacing with an external device and thus adjusts a common voltage; a signal control unit which outputs a first reverse signal that reverses the polarity of a voltage at intervals of at least two frames; and a data driving unit which reverses the polarity of an image data voltage with respect to the common voltage at intervals of at least two frames in response to the first reverse signal.

According to another aspect of the present invention, there is provided a display system including a host device and an LCD module which interfaces with the host device, the LCD module including a common-voltage adjustment unit which is enabled by interfacing with the host device and thus adjusts a common voltage, a signal control unit which outputs a first reverse signal that reverses the polarity of a voltage at intervals of at least two frames, and a data driving unit which reverses the polarity of an image data voltage with respect to the common voltage at intervals of at least two frames in response to the first reverse signal.

### BRIEF DESCRIPTION OF THE DRAWINGS

The above and other aspects and features of the present invention will become more apparent by describing in detail embodiments thereof with reference to the attached drawings, in which:

FIG. 1 illustrates a block diagram of a display system including a liquid crystal display (LCD) module according to an embodiment of the present invention;

FIG. 2 illustrates an equivalent circuit diagram of a pixel;

FIG. 3 illustrates a signal diagram for explaining the operation of the display system shown in FIG. 1;

FIG. 4 shows a table for explaining the operation of a data driving unit shown in FIG. 1;

FIG. 5 illustrates a block diagram of a display system including an LCD module according to another embodiment of the present invention;

FIG. 6 illustrates a block diagram of a display system including an LCD module according to another embodiment of the present invention; and

FIG. 7 illustrates a block diagram of a display system including an LCD module according to another embodiment of the present invention.

FIG. 8 illustrates operation of an LCD module and a display system including the same according to another embodiment of the present invention.

FIG. 9 illustrates operation of an LCD and a display system including the same according to another embodiment of the present invention.

FIG. 10 is a table illustrating operation of a display system of FIG. 9.

### DETAILED DESCRIPTION OF THE EXEMPLARY EMBODIMENTS

The present invention will now be described more fully with reference to the accompanying drawings, in which embodiments of the invention are shown. The invention may, however, be embodied in many different forms and should not be construed as being limited to the embodiments set forth herein. Rather, these embodiments are provided so that this disclosure will be thorough and complete, and will convey the concept of the invention to those skilled in the art.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers refer to like elements throughout. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Furthermore, relative terms such as “below,” “beneath,” or “lower,” “above,” and “upper” may be used herein to describe one element's relationship to another element as illustrated in the accompanying drawings. It will be understood that relative terms are intended to encompass different orientations of the device in addition to the orientation depicted in the accompanying drawings. For example, if the device in the accompanying drawings is turned over, elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the exemplary terms “below” and “beneath” can, therefore, encompass both an orientation of above and below.

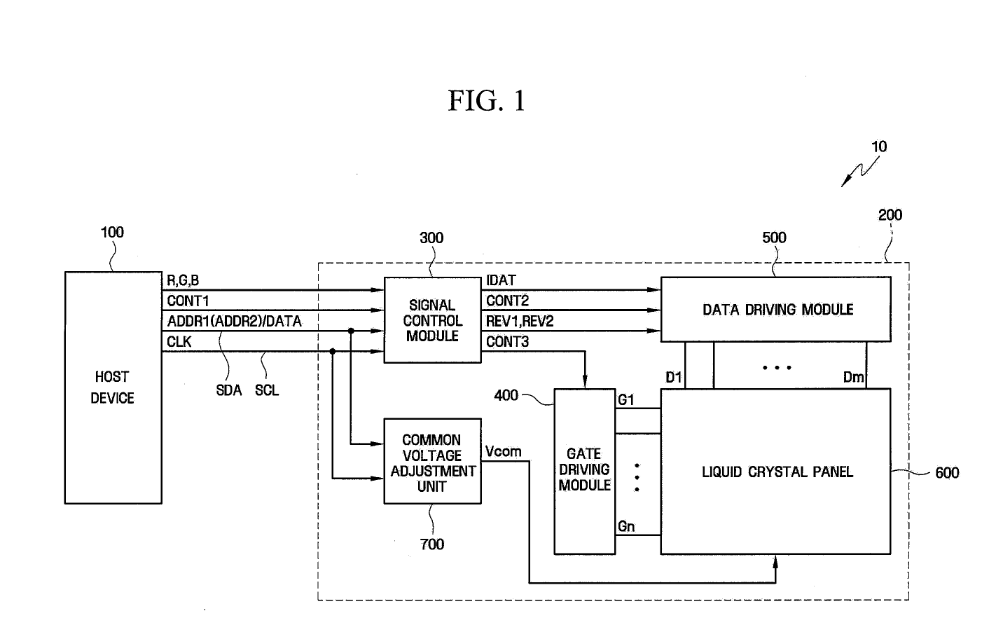

A liquid crystal display (LCD) module according to an embodiment of the present invention and a display system including the LCD module, according to an embodiment of the present invention will hereinafter be described in detail with reference to FIGS. 1 through 4.

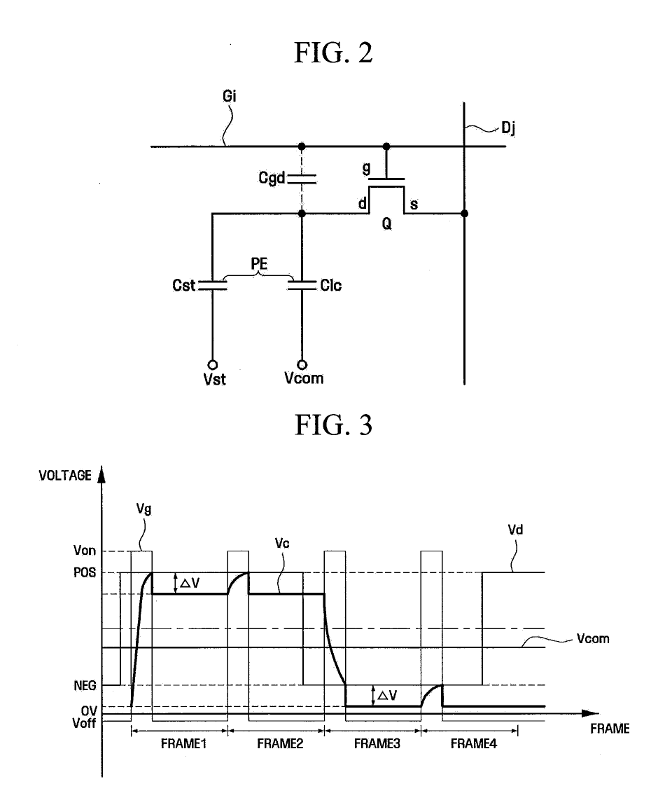

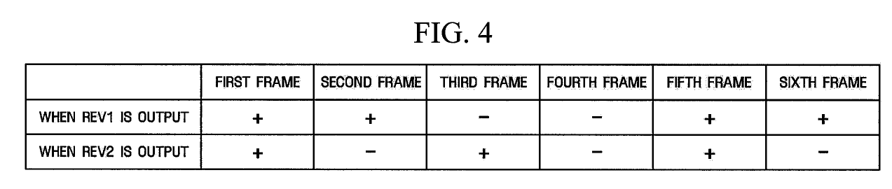

FIG. 1 illustrates a block diagram of a display system 10 including an LCD module 200 according to an embodiment of the present invention, FIG. 2 illustrates an equivalent circuit diagram of a pixel, FIG. 3 illustrates a signal diagram for explaining the operation of the display system 10, and FIG. 4 illustrates a table for explaining the operation of a data driving unit 500 illustrated in FIG. 1.

Referring to FIG. 1, the display system 10 includes a host device 100 and the LCD module 200.

The LCD module 200 includes a signal control unit 300, a gate driving unit 400, the data driving unit 500, a liquid crystal panel 600 and a common-voltage adjustment unit 700.

The signal control unit 300 receives a red-green-blue (RGB) image signal RGB and a first control signal CONT1 from the host device 100 and outputs an image data signal IDAT, a second control signal CONT2, a third control signal CONT3, and first and second reverse signals REV1 and REV2.

The image data signal IDAT may be obtained by converting the RGB image signal RGB in order to improve the speed of response and the display quality of an image. The second control signal CONT2 may include a horizontal initiation signal, which initiates the operation of the data driving unit 500, and an output command signal, which instructs an image data voltage to be output. The third control signal CONT3 may include a vertical initiation signal, which initiates the operation of the gate driving unit 400, a gate clock signal, which decides when to output a gate-on voltage, and an output enable signal, which determines the pulse width of the gate-on voltage. For example, the signal control unit 300 may output an image data signal IDAT so that the frame frequency of the LCD module 200 can become 120 Hz.

The signal control unit 300 may output the first reverse signal REV1 commanding reverse at intervals of at least two frames or the second reverse signal REV2 commanding reverse at intervals of a frame, according to whether the common-voltage adjustment unit 700 is enabled.

The data driving unit 500 converts the image data signal IDAT into an image data voltage and outputs the image data voltage to a plurality of data lines D1 through Dm by being controlled by the second control signal CONT2 input thereto by the signal control unit 300. If the first reverse signal REV1 is received, the data driving unit 500 may reverse the polarity of the image data voltage with respect to a common voltage Vcom at intervals of at least two frames. On the other hand, if the second reverse signal REV2 is received, the data driving unit 500 may reverse the polarity of the image data voltage with respect to a common voltage Vcom at intervals of a frame.

The gate driving unit 400 sequentially provides a gate signal to a plurality of gate lines G1 through Gn by being controlled by the third control signal CONT3 input thereto by the signal control unit 300.

The liquid crystal panel 600 includes a plurality of pixels (not shown), which are connected to the data lines D1 through Dm and the gate lines G1 through Gn. FIG. 2 illustrates an equivalent circuit diagram of each of the pixels. Referring to FIG. 2, a pixel includes a switching device Q, which is connected to an i-th gate line Gi and a j-th data line Dj, a liquid crystal capacitor Clc, and a storage capacitor Cst, which are both connected to the switching device Q. When an image data voltage is applied to a pixel electrode PE of the liquid crystal capacitor Clc, the liquid crystal capacitor Clc is charged with a voltage corresponding to the difference between the image data voltage and the common voltage Vcom, thereby displaying an image according to the difference between the image data voltage and the common voltage Vcom. The liquid crystal capacitor Clc and the storage capacitor Cst may share the pixel electrode PE as their first terminals. A storage voltage may be applied to a second terminal of the storage capacitor Cst.

The common-voltage adjustment unit 700 may output a uniform voltage level, i.e., the common voltage Vcom, when being disabled. However, if the common-voltage adjustment unit 700 is enabled through an interfacing with the host device 100, the common-voltage adjustment unit 700 may adjust the common voltage Vcom. That is, the host device 100 may enable the common-voltage adjustment unit 700 to adjust the common voltage Vcom and may thus reduce flicker.

It will hereinafter be described how the host device 100 can reduce flicker by adjusting the common voltage Vcom.

The host device 100 outputs the RGB image signal RGB and the first control signal CONT1. The first control signal CONT1 may include a vertical synchronization signal, a horizontal synchronization signal, a main clock signal and a data enable signal.

The host device 100 may interface with the LCD module 200. For example, the host device 100 may interface with the LCD module 200 through an inter-integrated circuit (I²C) interface, which is a type of serial digital interface. The I²C interface is a 2-wire interface and includes a serial data line SDA for data communication between a master and a slave and a serial clock line SCL for the control and the synchronization of data communication between a master and a slave.

That is, referring to FIG. 1, the host device 100, which is a master, may provide a data signal DATA through a serial data line SDA and provide a clock signal CLK through a serial clock line SCL. In addition, the host device 100, which is a master, may control the signal control unit 300 and the common-voltage adjustment unit 700, which are both slaves, through the serial data line SDA and the serial clock line SCL. In one example, the host device 100 may be a signal processing device in a television (TV) set. In this case, the display system 10 may be the TV set. Alternatively, the host device 100 may be a computer. Still alternatively, the host device 100 may be a test device for reducing flicker in the LCD module 200. In this case, the host device 100 may not output the RGB image signal RGB and the first control signal CONT1.

More specifically, the host device 100 may output a first enable signal ADDR1 to the common-voltage adjustment unit 700 through the serial data line SDA in order to adjust the common voltage Vcom. Since the host device 100 and the common-voltage adjustment unit 700 interface with each other through an I²C interface, the first enable signal ADDR1 may be an address signal for enabling the common-voltage adjustment unit 700. Therefore, the first enable signal ADDR1 will hereinafter be referred to as the first address signal ADDR1. The host device 100 may output the data signal DATA through the serial data line SDA after the output of the first address signal ADDR1.

The common-voltage adjustment unit 700 is enabled in response to the first address signal ADDR1, and receives the data signal DATA, which is output by the host device 100 after the output of the first address signal ADDR1. The common-voltage adjustment unit 700 adjusts the common voltage Vcom according to the data signal DATA.

The first address signal ADDR1 is provided to the signal control unit 300 through the serial data line SDA, and the signal control unit 300, like the common-voltage adjustment unit 700, is enabled in response to the first address signal ADDR1. The signal control unit 300 outputs the first reverse signal REV1, which reverses the polarity of a voltage at intervals of at least two frames.

The host device 100 may also output a second address signal ADDR2 in order to control the signal control unit 300. In this case, the signal control unit 300 is enabled in response to the second address signal ADDR2, receives the data signal DATA, which is output by the host device 100 after the output of the second address signal ADDR2, and is driven according to the data signal DATA. For example, the signal control unit 300 may process the RGB image signal RGB differently according to the data signal DATA. The common-voltage adjustment unit 700, unlike the signal control unit 300, does not respond to the second address signal ADDR2.

In short, if the host device 100 outputs the first address signal ADDR1 in order to control the common-voltage adjustment unit 700, the signal control unit 300 outputs the first reverse signal REV1 in response to the first address signal ADDR1. The common-voltage adjustment unit 700 adjusts the common voltage Vcom according to the data signal DATA, which is output by the host device 100 after the output of the first address signal ADDR1, in response to the first address signal ADDR1. On the other hand, if the host device 100 outputs the second address signal ADDR2 in order to control the signal control unit 300, only the signal control unit 300 is enabled in response to the second address signal ADDR2 and is thus driven according to the data signal DATA, which is output by the host device 100 after the output of the second address signal ADDR2.

It will hereinafter be described in further detail with reference to FIG. 3 how the host device 100 can reduce flicker by adjusting the common voltage Vcom.

In order to reduce flicker, the host device 100 may output the first address signal ADDR1. The signal control unit 300 may output the first reverse signal REV1 in response to the first address signal ADDR1. As a result, the data driving unit 500 may output the image data signal IDAT whose polarity is reversed with respect to the common voltage Vcom, for example, at intervals of two frames, as illustrated in FIG. 3. Referring to FIGS. 2 and 3, a gate signal Vg has a gate-on voltage Von or a gate-off voltage Voff, and is provided to the i-th gate line Gi at intervals of a frame. During first and second frames FRAME1 and FRAME2, an image data voltage Vd is output to the j-th data line Dj as a positive image data voltage POS, which is positive with respect to the common voltage Vcom. During third and fourth frames FRAME3 and FRAME4, the image data voltage Vd is output to the j-th data line Dj as a negative image data voltage NEG, which is negative with respect to the common voltage Vcom.

More specifically, if the gate-on voltage Von is applied to a gate electrode g of the switching device Q during the first frame FRAME1, the pixel electrode PE can be charged with the positive image data voltage POS. Then, if the gate-off voltage Voff is applied to the gate electrode g, a voltage drop may occur in the gate electrode g, and thus, coupling may occur due to a parasitic capacitor Cgd, thereby reducing a voltage Vc of the pixel electrode PE. This type of phenomenon is referred to as a kickback phenomenon. Due to the kickback phenomenon, the voltage Vc of the pixel electrode PE is reduced from the positive image data voltage POS by as much as a kickback voltage ΔV. If the gate-on voltage Von is applied to the gate electrode g during the second frame FRAME2, the pixel electrode PE is charged again with the positive image data voltage POS. Then, if the gate-off voltage is applied to the gate electrode g, the voltage Vc of the pixel electrode PE may also be reduced by as much as the kickback voltage ΔV due to the kickback phenomenon. Likewise, during the third and fourth frames FRAME3 and FRAME4, the voltage Vc of the pixel electrode PE may be reduced from the image data voltage NEG by as much as the kickback voltage ΔV.

That is, the voltage Vc of the pixel electrode PE is reduced by a predetermined amount due to the kickback phenomenon, and thus, the root mean square (RMS) values of the positive image data voltage POS and the negative image data voltage NEG may differ from each other, thereby causing flicker.

The host device 100 may provide the first address signal ADDR1 and then the data signal DATA to the common-voltage adjustment unit 700, and may thus enable the common-voltage adjustment unit 700 to adjust the common voltage Vcom. For example, the host device 100 may adjust the common voltage Vcom so that the RMS values of the positive image data voltage POS and the negative image data voltage NEG can become equal.

In reality, a user or a manufacturer may adjust the common voltage Vcom with the use of the host device 100, the common-voltage adjustment unit 700, and the signal control unit 300 while examining whether flicker is seen from the LCD module 200. If the frame frequency of the LCD module 200 is 60 Hz, flicker may be clearly seen, and thus, a user or a manufacturer may be able to sophisticatedly or sensitively adjust the common voltage Vcom and thus minimize flicker. However, if the frame frequency of the LCD module 200 is 120 Hz, flicker may not be seen clearly, and thus, a user or a manufacturer may not be able to sophisticatedly adjust the common voltage Vcom and thus minimize flicker. Therefore, when the adjustment of flicker is performed, i.e., when the common-voltage adjustment unit 700 is enabled, the signal control unit 300 outputs the first reverse signal REV1 to the data driving unit 500 and thus drives the data driving unit 500 in a similar manner to that of the data driving unit 500 when the frame frequency of the LCD module 200 is 60 Hz. That is, referring to FIG. 3, each pixel is charged with an image data voltage whose polarity is reversed with respect to the common voltage Vcom at intervals of two frames, and thus, the LCD module 200 may be driven as if the frame frequency of the LCD module 200 were 60 Hz. Therefore, a user or a manufacturer may be able to sophisticatedly adjust the common voltage Vcom and thus minimize flicker. In this manner, it is possible to improve the display quality of an image.

In a normal driving mode, unlike in a mode for adjusting the common voltage Vcom, the signal control unit 300 outputs the second reverse signal REV2. Then, the data driving unit 500 may output, in response to the second reverse signal REV2, an image data voltage whose polarity is reversed with respect to the common voltage Vcom at intervals of a frame. FIG. 4 is a table showing the variation of the polarity of an image data signal according to the first or second reverse signals REV1 or REV2. When the host device 100 outputs the first address signal ADDR1, the signal control unit 300 outputs the first reverse signal REV1. Then, the data driving unit 500 may output, in response to the first reverse signal REV1, an image data voltage whose polarity is reversed with respect to the common voltage Vcom at intervals of two frames. On the other hand, in the normal driving mode, the signal control unit 300 outputs the second reverse signal REV2. Then, the data driving unit 500 may output, in response to the second reverse signal REV2, an image data voltage whose polarity is reversed with respect to the common voltage Vcom at intervals of a frame. The data driving unit 500 may output, in response to the first reverse signal REV1, an image data voltage whose polarity is reversed with respect to the common voltage Vcom at intervals of three or more frames.

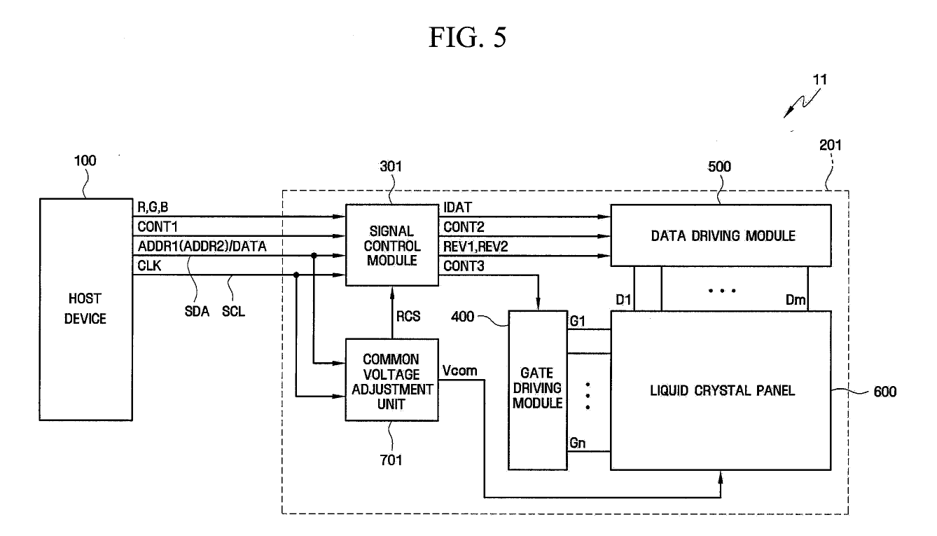

An LCD module according to another embodiment of the present invention and a display system including the LCD module, according to another embodiment of the present invention will hereinafter be described in detail with reference to FIG. 5. FIG. 5 illustrates a block diagram of a display system 11 including an LCD module 201 according to another embodiment of the present invention. In FIGS. 1 and 5, like reference numerals indicate like elements, and thus, detailed descriptions thereof will be skipped.

Referring to FIG. 5, when a host device 101 {PLEASE RELABLE HOST DEVICE IN FIG. 5 FROM “100” TO “101”} outputs a first address signal ADDR1 in order to adjust flicker, a common-voltage adjustment unit 701 is enabled in response to the first address signal ADDR1 and thus outputs a reverse control signal RCS to a signal control unit 301. In addition, the common-voltage adjustment unit 701 adjusts a common voltage Vcom according to a data signal DATA, which is output by the host device 101 after the output of the first address signal ADDR1. The signal control unit 301 does not respond to the first address signal ADDR1. Instead, the signal control unit 301 outputs a first reverse signal REV1 in response to the reverse control signal RCS. When the host device 101 outputs a second address signal ADDR2, only the signal control unit 301 responds to the second address signal ADDR2 and is thus driven according to a data signal DATA, which is output by the host device 101 after the output of the second address signal ADDR2.

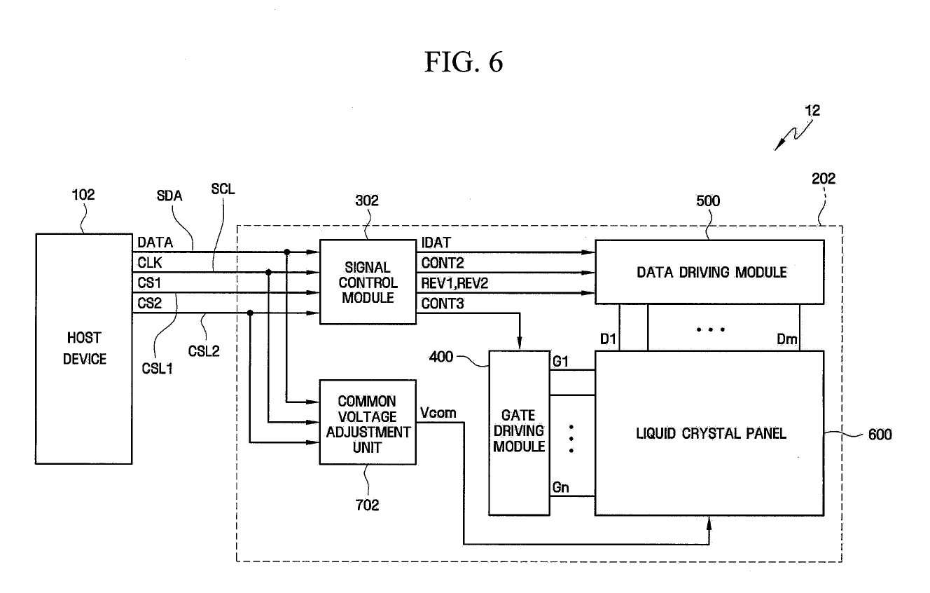

An LCD module according to another embodiment of the present invention and a display system including the LCD module, according to another embodiment of the present invention will hereinafter be described in detail with reference to FIG. 6. FIG. 6 illustrates a block diagram of a display system 12 including an LCD module 202 according to another embodiment of the present invention. In FIGS. 1 and 6, like reference numerals indicate like elements, and thus, detailed descriptions thereof will be skipped.

Referring to FIG. 6, a host device 102 interfaces with a signal control unit 302 and a common-voltage adjustment unit 702 through a serial peripheral interface (SPI), which is a type of serial digital interface. More specifically, the host device 102 interfaces with the signal control unit 302 and the common-voltage adjustment unit 702 through a serial data line SDA, a serial clock line SCL and first and second chip select lines CSL1 and CSL2. In the embodiment of FIG. 1, the host device 100 interfaces with the signal control unit 300 and the common-voltage adjustment unit 700 through an I²C interface, and chooses one of the signal control unit 300 and the common-voltage adjustment unit 700 as a slave to be controlled by outputting the first address signal ADDR1 through the serial data line SDA. On the other hand, in the embodiment of FIG. 6, the host device 102 chooses one of the signal control unit 302 and the common-voltage adjustment unit 702 by using the first and second chip select lines CSL1 and CSL2. For example, the host device 102 may output a first chip select signal CS1 in order to choose and control the signal control unit 302, or may output a second chip select signal CS2 in order to choose and control the common-voltage adjustment unit 702. Since the signal control unit 302 is connected to the second chip select line CSL2, the signal control unit 302 is provided with the second chip select signal CS2. The host device 102 may output a data signal DATA to the signal control unit 302 and the common-voltage adjustment unit 702 through the serial data line SDA. The display system 12 may also include an additional serial data line (not shown) for transmitting data from each slave (e.g., the signal control unit 302 and the common-voltage adjustment unit 702) to the host device 102.

The adjustment of flicker by the display system 12 will hereinafter be described in detail. In order to adjust flicker, the host device 102 may output the second chip select signal CS2, which has a high level. Then, the common-voltage adjustment unit 702 is enabled in response to the second chip select signal CS2. The second chip select signal CS2 is also provided to the signal control unit 302 through the second chip select line CSL2. Accordingly, the signal control unit 302 is enabled in response to the second chip select signal CS2 and outputs a second reverse signal REV2. When the host device 102 outputs the data signal DATA through the serial data line SDA, the common-voltage adjustment unit 702 adjusts a common voltage according to the data signal DATA.

In order to control only the signal control unit 302, the host device 102 may output the first chip select signal CS1. Then, the signal control unit 302 is enabled in response to the first chip select signal CS1 and is driven according to the data signal DATA input thereto through the serial data line SDA. Since the common-voltage adjustment unit 702 is not connected to the first chip select line CSL1, the common-voltage adjustment unit 702 does not respond to the first chip select line CSL1.

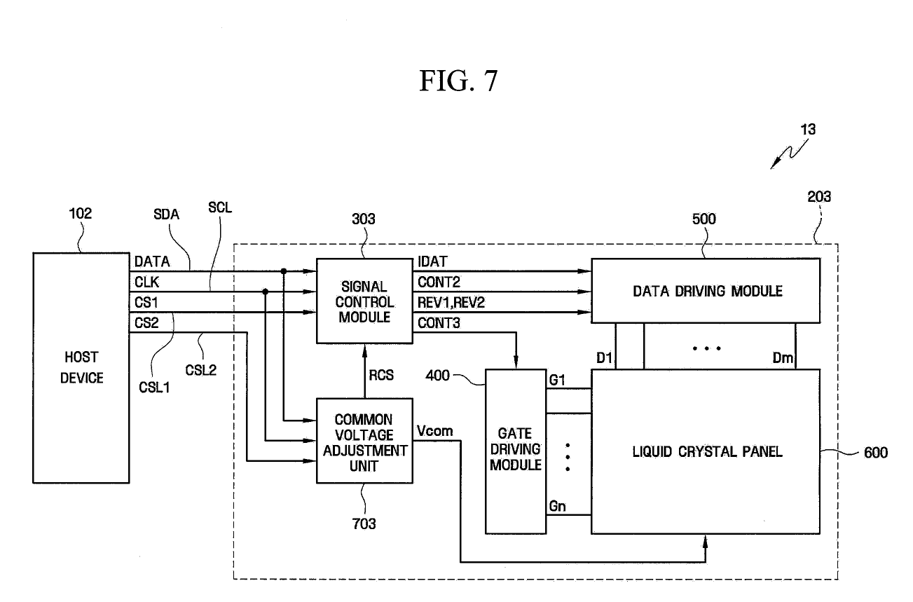

An LCD module according to another embodiment of the present invention and a display system including the LCD module, according to another embodiment of the present invention will hereinafter be described in detail with reference to FIG. 7. FIG. 7 illustrates a block diagram of a display system 13 including an LCD module 203 according to another embodiment of the present invention. In FIGS. 1 and 7, like reference numerals indicate like elements, and thus, detailed descriptions thereof will be skipped.

Referring to FIG. 7, a signal control unit 303 is not connected to a second chip select line CSL2. Thus, a second chip select signal CS2 is not provided to the signal control unit 303. Instead, a reverse control signal RCS is provided to the signal control unit 303 by a common-voltage adjustment unit 703.

More specifically, in order to adjust flicker, a host device 103 may output the second chip select signal CS2. Then, the common-voltage adjustment unit 703 is enabled in response to the second chip select signal CS2 and outputs the reverse control signal RCS to the signal control unit 303. The signal control unit 303 outputs a first reverse signal REV1 in response to the reverse control signal RCS. In addition, the common-voltage adjustment unit 703 is provided with a data signal DATA through a serial data line SDA and outputs a common voltage Vcom according to the data signal DATA.

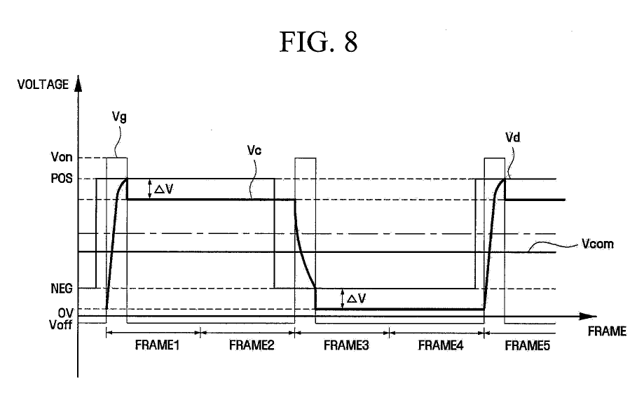

An LCD module according to another embodiment of the present invention and a display system including the LCD module, according to another embodiment of the present invention will hereinafter be described in detail with reference to FIG. 8. FIG. 8 illustrates a signal diagram for explaining the operation of the display system according to another embodiment of the present invention. The description of the elements that have been explained above will be omitted for explanatory convenience.

Referring to FIG. 8, a host apparatus (not shown) of an LCD module and a display system including the LCD according to another embodiment of the present invention outputs a first address signal (ADDR1), as mentioned above. In response to the first address signal (ADDR1), the signal control unit outputs the first reverse signal (REV1). Hence, a gate driving unit, for example, outputs image data signals (Vd) whose polarity is reversed based on the common voltage (Vcom) for respective two frames, as shown in FIG. 8.

As shown in FIG. 8, an LCD module and a gate on/off voltage (Von/Voff) of a display system including the LCD according to another embodiment of the present invention are provided to Ith gate line (Gi) of FIG. 2, for example, for respective two frames. Further, an image data voltage (Vd) outputs an image data voltage (POS) of positive polarity, based on common voltage (Vcom) in the first frame (FRAME1) and the second frame (FRAME2), and outputs image data voltage (NEG) of negative polarity to the jth data line (Dj) in the third frame (FRAME3) and the fourth frame (FRAME4). Specifically, an LCD and a display system including the LCD according to another embodiment of the present invention outputs a first reserve signal (REV1) that indicates the reverse turn for at least respective two frames, and outputs a first vertical start signal that indicates the output of a gate signal for at least respective two frames when adjusting a flicker, i.e., a common voltage adjustment unit is enabled.

The frame frequency of the LCD module can be made to operate in a manner that is similar to the operation of a frequency that is lower than an actually operating frequency by providing the first reverse signal (REV1) and the vertical start signal (STV) at least per two frames. In other words, as shown in FIG. 8, the image data voltage of the same polarity is charged to the pixels in two frame units based on the common voltage (Vcom), and the gate signal (Vg) can also be authorized to each pixel per two frame units. Hence, the voltage (Vc) of the pixel voltage (PE) can be charged in two frame units.

For example, in the case where a frame frequency is 120 Hz at a normal operation, it is operated in a manner that is similar to the situation when the frame frequency is 60 Hz when adjusting the common voltage. Hence, the common voltage (Vcom) level can be minutely adjusted in order to minimize the flickering of the user or the maker, and it can be adjusted to be even more similar to the optimal common voltage (Vcom) level, which are advantageous.

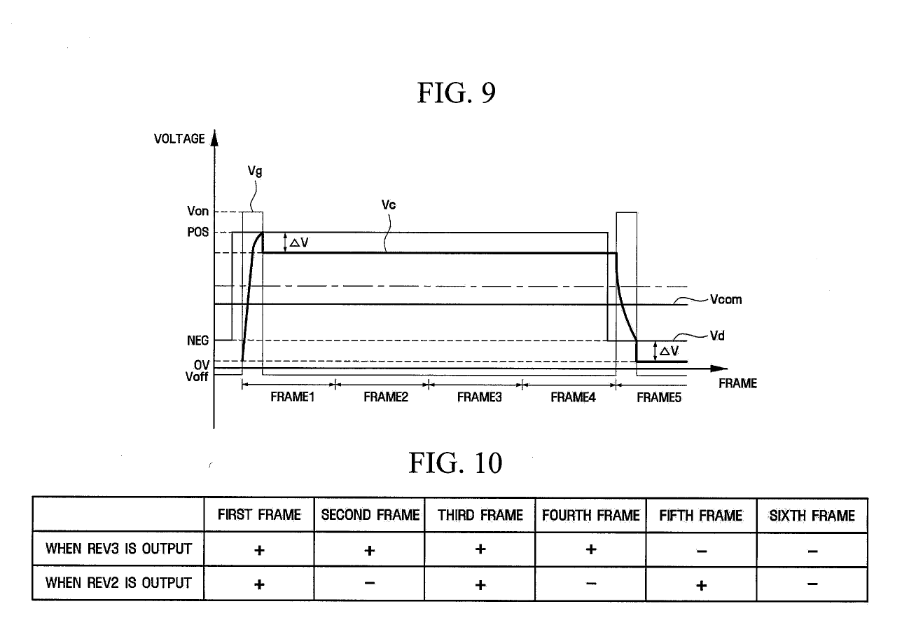

Likewise, an LCD and a display system including the LCD according to another embodiment of the present invention outputs a second reverse signal (REV2) that indicates the reverse turn per frame, and outputs the second vertical start signal that indicates the gate output per frame at the time of normal operation, that is, when a common voltage adjustment unit is disabled, which was described above, so the detailed description is omitted here. Further, as shown in FIGS. 9 and 10, when a common voltage adjustment unit is enabled, the signal control unit can output a third reverse signal (REV3) that indicates the reverse turn per four frames.

Specifically, polarities of image data voltages according to reverse signals (REV1, REV2) have been classified as a table, which is shown in FIG. 10. As shown in FIG. 10, a third reverse signal (REV3) provided by the signal control unit can output the voltage of image data in which polarity is reversed based on the common voltage per four frames. Further, at the time of normal operation, the signal control unit 300 outputs the second reverse signal (REV2). If the second reverse signal (REV2) is inputted, the data-driving unit 500 can output the image data voltage whose polarity is reversed based on the common voltage (Vcom) per frame.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display (LCD) module comprising:
a common-voltage adjustment unit which is enabled by interfacing with an exterior device to adjust a common voltage;
a signal control unit which outputs a first reverse signal that reverses the polarity of a voltage at intervals of at least two frames when the common-voltage adjustment unit is enabled; and
a data driving unit which reverses the polarity of an image data voltage with respect to the common voltage at intervals of at least two frames in response to the first reverse signal.

2. The LCD module of claim 1, wherein if the common-voltage adjustment unit is disabled, the signal control unit outputs a second reverse signal that reverses the polarity of a voltage at intervals of a frame, and the data driving unit reverses the polarity of the image data voltage with respect to the common voltage at intervals of a frame in response to the second reverse signal.

3. The LCD module of claim 2, wherein the signal control unit outputs a first vertical start signal that instructs the output of a gate signal per at least two frames when the common-voltage adjustment unit is enabled, and outputs a second vertical start signal that instructs the output of the gate signal per frame when the common-voltage adjustment unit is disabled.

4. The LCD module of claim 1, wherein the common-voltage adjustment unit and the signal control unit interface with the exterior device through a serial digital interface.

5. The LCD module of claim 4, wherein the common-voltage adjustment unit is enabled in response to a first enable signal provided by the exterior device and adjusts the common voltage according to a first data signal provided by the exterior device.

6. The LCD module of claim 5, wherein the signal control unit outputs the first reverse signal in response to the first enable signal.

7. The LCD module of claim 6, wherein the signal control unit is enabled in response to a second enable signal and is driven according to a second data signal provided by the external device and the common-voltage adjustment unit does not respond to the second enable signal.

8. The LCD module of claim 5, wherein the common-voltage adjustment unit outputs a reverse control signal to the signal control unit in response to the first enable signal and the signal control unit outputs the first reverse signal in response to the reverse control signal.

9. The LCD module of claim 4, wherein the common-voltage adjustment unit interfaces with the external device through a serial peripheral interface (SPI).

10. The LCD module of claim 4, wherein the common-voltage adjustment unit interfaces with the external device through an inter-integrated circuit (I²C) interface.

11. A display system comprising:
a host device; and
a liquid crystal display (LCD) module which interfaces with the host device, the LCD module comprising a common-voltage adjustment unit which is enabled by interfacing with the host device to adjust a common voltage, a signal control unit which outputs a first reverse signal that reverses the polarity of a voltage at intervals of at least two frames, and a data driving unit which reverses the polarity of an image data voltage with respect to the common voltage at intervals of at least two frames in response to the first reverse signal.

12. The display system of claim 11, wherein if the common-voltage adjustment unit is disabled, the signal control unit outputs a second reverse signal that reverses the polarity of a voltage at intervals of a frame, and the data driving unit reverses the polarity of the image data voltage with respect to the common voltage at intervals of a frame in response to the second reverse signal.

13. The display system of claim 12, wherein the signal control unit outputs a first vertical start signal that instructs the output of a gate signal per at least two frames when the common-voltage adjustment unit is enabled, and outputs a second vertical start signal that instructs the output of the gate signal per frame when the common-voltage adjustment unit is disabled.

14. The display system of claim 11, further comprising a serial data line and a serial clock line, wherein the LCD module interfaces with the host device through an I²C interface.

15. The display system of claim 14, wherein the common-voltage adjustment unit is enabled in response to a first address signal transmitted thereto through the serial data line by the host device and adjusts the common voltage according to a first data signal transmitted thereto through the serial data line.

16. The display system of claim 15, wherein the signal control unit outputs the first reverse signal in response to the first address signal.

17. The display system of claim 16, wherein the signal control unit is enabled in response to a second address signal transmitted thereto through the serial data line by the host device and is driven according to a second data signal transmitted thereto through the serial data line, and the common-voltage adjustment unit does not respond to the second address signal.

18. The display system of claim 15, wherein the common-voltage adjustment unit outputs a reverse control signal to the signal control unit in response to the first address signal and the signal control unit outputs the first reverse signal in response to the reverse control signal.

19. The display system of claim 11, further comprising first and second chip select lines, a serial data line, and a serial clock line, wherein the LCD module interfaces with the host device through a serial peripheral interface (SPI).

20. The display system of claim 19, wherein the common-voltage adjustment unit is enabled in response to a first chip select signal transmitted thereto through the first chip select line by the host device and adjusts the common voltage according to a first data signal transmitted thereto through the serial data line.

21. The display system of claim 20, wherein the signal control unit is connected to the first chip select line and outputs the first reverse signal in response to the first chip select signal.

22. The display system of claim 21, wherein the signal control unit is enabled in response to a second chip select signal transmitted thereto through the second chip select line by the host device and is driven according to a second data signal transmitted thereto through the serial data line, and the common-voltage adjustment unit is not connected to the second chip select line.
